(19) United States
(12) Patent Application Publication
(10) Pub. No.: US 2011/0065019 A1
(43) Pub. Date: Mar. 17, 2011

(54) COMBINED CELL MODULE FOR SOLID OXIDE FUEL CELL

(76) Inventor: Shunsuke Taniguchi, Suwon-si (KR)

(21) Appl. No.: 12/748,114

(22) Filed: Mar. 26, 2010

Related U.S. Application Data
(60) Provisional application No. 61/242,689, filed on Sep. 15, 2009.

(51) Int. Cl. H01M 8/10

(52) U.S. Cl. 429/488

(57) ABSTRACT

A combined cell module for a solid oxide fuel cell includes: a first sub-cell; a second sub-cell; a connector between the first and second sub-cells, each of the first and second sub-cells having a hollow portion extending along its length direction, each of the first and second sub-cells including: a first electrode; a second electrode; an electrolyte layer between the first and second electrodes; and a support member extending along the length direction within the hollow portion, the support members of the first and second sub-cells being physically coupled to each other via the connector, and at least one of the first electrode or the second electrode of the first sub-cell being electrically coupled to at least one of the first electrode or the second electrode of the second sub-cell via the connector.

### CROSS-REFERENCE TO RELATED APPLICATION

This application claims priority to and the benefit of U.S. Patent Application No. 61/242,689, filed on Sep. 15, 2009, in the United States Patent and Trademark Office, the entire content of which is incorporated herein by reference.

### BACKGROUND

1. Field

The present invention relates to a combined cell module in which multiple solid oxide fuel cells are combined in series.

2. Description of Related Art

Solid oxide fuel cells (SOFCs) can generate power with relatively low pollution, high-efficiency, and the like. The SOFCs can be utilized in stationary power generation systems, small independent sources, and vehicle power sources. An SOFC cell may be manufactured as a tube-type cell, a flat-tube-type cell, or a flat-plate-type cell. The tube-type or flat-tube-type cell may be manufactured to have a structure for a cathode supported cell, a segmented in series cell, an anode supported cell, or the like.

Generally, anode supported SOFC cells are used for small SOFC systems in the range of 1 to 10 KW. On the other hand, cathode supported SOFC cells or segmented in series cells are used for large SOFC systems in the range of 100 KW or more.

### SUMMARY

An aspect of an embodiment of the present invention is directed toward a combined cell module for a solid oxide fuel cell (SOFC) with a structure in which a plurality of anode supported SOFC cells are combined in series that is capable of can improving mechanical stability and reliability.

Another aspect of an embodiment of the present invention, is directed toward a combined cell module for an SOFC for which a large-size SOFC system using a plurality of anode supported SOFC cells can be effectively designed and manufactured.

An embodiment of the present invention provides a combined cell module for a solid oxide fuel cell, including: a first sub-cell; a second sub-cell; a connector between the first and second sub-cells, each of the first and second sub-cells having a hollow portion extending along its length direction, each of the first and second sub-cells including: a first electrode; a second electrode; an electrolyte layer between the first and second electrodes; and a support member extending along the length direction within the hollow portion, the support members of the first and second sub-cells being physically coupled to each other via the connector, and at least one of the first electrode or the second electrode of the first sub-cell being electrically coupled to at least one of the first electrode or the second electrode of the second sub-cell via the connector.

The second electrode of the first sub-cell may be electrically coupled in series to the first electrode of the second sub-cell via the connector.

The combined cell module may further include an insulating sealing member between the connector and the first sub-cell and configured to electrically insulate the first electrode of the first sub-cell from the first electrode of the second-sub cell.

The support members of the first and second sub-cells may be screw coupled to each other via the connector at the central axis of the combined cell module.

The connector may include a body having at least one through-hole opening configured to allow a fluid to flow between the first sub-cell and the second sub-cell.

The at least one through-hole opening may include a plurality of through-hole openings around the central axis of the combined cell module.

The connector may include a body and a coupling portion protruding from the body, the coupling portion being configured to couple the connector to the support member of at least one of the first sub-cell or the second sub-cell.

The coupling portion may have a screw thread, and the support member of at least one of the first sub-cell or the second sub-cell may have a corresponding screw thread at an end thereof and be configured to engage with the screw thread of the coupling portion.

The screw thread of the support member may be a male screw thread, and the screw thread of the coupling portion may be a female screw thread.

The support member may have a screw thread at each end thereof to enable the support member to be connected between the connector and another connector, and the coupling portion of the connector may have a screw thread at each end thereof to enable the connector to be connected between the support members of the first and second sub-cells.

The connector may be integrally provided with the support member of the second sub-cell.

The support member may have a first screw thread, the connector may have a second screw thread, and the first screw thread of the support member of the first sub-cell may be configured to be screwed into the second screw thread of the connector.

The combined cell module may further include a coupling portion configured to couple the support member of the first sub-cell to the connector.

The coupling portion may have a double male-ended screw thread configured for insertion into a female screw thread of the connector and a female screw thread of the support member of the first sub-cell.

The combined cell module may further include a current collecting layer on the second electrode, on the electrolyte layer and on the connector.

The combined cell module may further include a conducting porous member within the hollow portion, wherein the porous member is between the first electrode and the support member, and the current collecting layer of the first sub-cell is in contact with the conducting porous member of the second sub-cell between the first electrode of the second sub-cell and the support member of the second sub-cell.

The combined cell module may further include a resilient portion, wherein the connector includes a main body and a support member body, the resilient portion being connected to the main body.

The resilient portion may be adapted to expand and contract between the first and second sub-cells so as to reduce the effects of thermal expansion.

The combined cell module may further include a current collecting layer on the second electrode and an interconnection coupling the current collecting layer to the connector across the resilient portion, the interconnection being configured to electrically couple the first and second sub-cells to each other.

The connector may include a first material, the support member may include a second material, the first and second materials may have different coefficients of thermal expansion, and relative lengths of the coupling portion and the support member may be configured to reduce the effects of thermal expansion.

In one embodiment of the present invention, the combined cell includes a buffer portion. The buffer portion is disposed between the support members of the first and second sub-cells. The buffer portion includes a coupling portion having a different thermal expansion coefficient from that of the support member. The length of the coupling portion is determined to reduce a difference of thermal expansion coefficients between the cells and the support members.

In one embodiment, the buffer portion includes a resilient portion disposed between the tube-type cell of the first sub-cell and the connector. In one embodiment of the present invention, the length of the coupling member may be configured to reduce the difference between thermal expansion coefficients between the cells and the support members

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic front view of a combined cell module for a solid oxide fuel cell (hereinafter, referred to as an SOFC combined cell module or a combined cell module) according to a first embodiment of the present invention.

FIG. 2 is a schematic cross-sectional view of the SOFC combined cell module according to the first embodiment of the present invention.

FIG. 3A is a schematic cross-sectional view of a sub-cell of the combined cell module of FIG. 2.

FIG. 3B is a schematic exploded cross-sectional view of the sub-cell of FIG. 3A.

FIG. 4A is a schematic front view of an A-type support member of FIG. 3B.

FIG. 4B is a schematic right side view of the A-type support member of FIG. 4A.

FIG. 5A is a schematic front view of an A-type connector of FIG. 3B.

FIG. 5B is a schematic left side view of the A-type connector of FIG. 5A.

FIG. 5C is a schematic right side view of the A-type connector of FIG. 5A.

FIG. 6 is a schematic front view of a combined cell module according to a second embodiment of the present invention.

FIG. 7 is a schematic cross-sectional view of the combined cell module according to the second embodiment of the present invention.

FIG. 8 is a schematic cross-sectional view of a sub-cell of the combined cell module of FIG. 7.

FIG. 9A is a schematic front view of a support member integrated with a connector (hereinafter, referred to as a B-type support member), used in the combined cell module of FIG. 7.

FIG. 9B is a schematic longitudinal cross-sectional view of the B-type support member of FIG. 9A.

FIG. 9C is a schematic left side view of the B-type support member of FIG. 9A.

FIG. 9D is a schematic right side view of the B-type support member of FIG. 9A.

FIG. 10 is a schematic front view of a B-type coupling portion used in the combined cell module of FIG. 7.

FIG. 11 is a schematic front view of a combined cell module according to a third embodiment of the present invention.

FIG. 12 is a cross-sectional view of the combined cell module according to the third embodiment of the present invention.

FIG. 13 is a schematic cross-sectional view of a sub-cell of the combined cell module of FIG. 12.

FIG. 14A is a schematic front view of a support member integrated with a connector and a resilient portion (hereinafter, referred to as a C-type support member), used in the combined cell module of FIG. 12.

FIG. 14B is a schematic longitudinal cross-sectional view of the C-type support member of FIG. 14A.

FIG. 14C is a schematic left side view of the C-type support member of FIG. 14A.

FIG. 14D is a schematic right side view of the C-type support member of FIG. 14A.

FIG. 15 is a schematic front view a C-type coupling member applicable to the combined cell module of FIG. 12.

FIG. 16 is a schematic front view of a combined cell module according to a fourth embodiment of the present invention.

FIG. 17 is a schematic cross-sectional view of the combined cell module according to the fourth embodiment of the present invention.

FIG. 18 is a schematic cross-sectional view of a sub-cell of the combined cell module of FIG. 17.

FIG. 19A is a schematic front view of a support member integrated with a connector and a resilient portion (hereinafter, referred to as a D-type support member), used in the combined cell module of FIG. 17.

FIG. 19B is a schematic longitudinal cross-sectional view of the D-type support member of FIG. 19A.

FIG. 19C is a schematic left side view of the D-type support member of FIG. 19A.

FIG. 19D is a schematic right side view of the D-type support member of FIG. 19A.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the drawings, the thickness and size of layers may be exaggerated for clarity.

The manifold mentioned in the following description refers to a structure provided with a flow path for smoothly supplying, distributing or discharging a fluid. In the description related to the accompanying drawings, a housing or boundary wall forming a manifold is designated by a reference numeral and referred to as the manifold, for convenience of illustration.

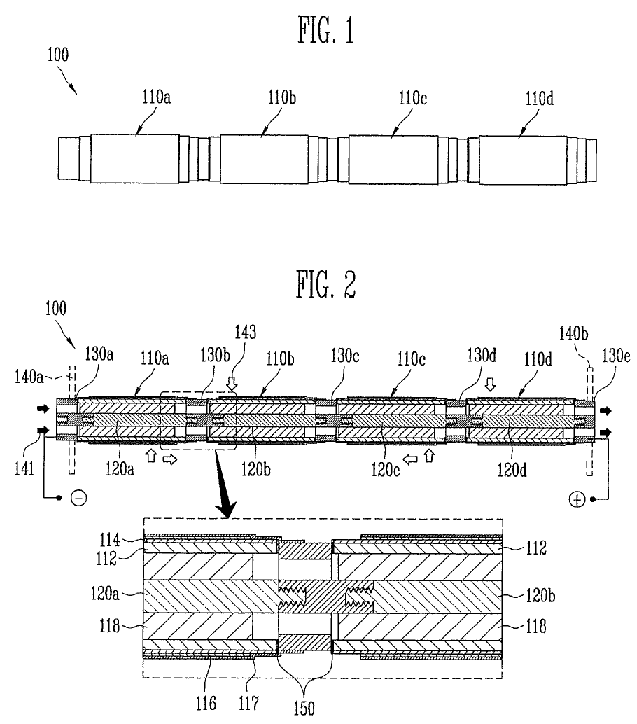

FIG. 1 is a schematic front view of a combined cell module for a solid oxide fuel cell (hereinafter, referred to as an SOFC combined cell module or a combined cell module) according to a first embodiment of the present invention. FIG. 2 is a schematic cross-sectional view the SOFC combined cell module according to the first embodiment of the present invention.

Referring to FIGS. 1 and 2, the combined cell module 100 is manufactured by combining a plurality of SOFC sub-cells 110a, 110b, 110c and 110d with the same structure with one another in series in the flow direction of a fuel. Here, each of the SOFC sub-cells becomes a unit cell structure for manufacturing the combined cell module 100. A connector 130a, 130b, 130c or 130d (hereinafter, referred to as an A-type connector) may be provided between adjacent SOFC sub-cells.

Each of the sub-cells 110a, 110b, 110c and 110d includes a plurality of tube-type SOFC cells and an A-type support member 120a, 120b, 120c or 120d inserted into a hollow portion of each of the SOFC cells. Hereinafter, each of the SOFC cells is referred to as a cell. Each of the cells has a structure in which an anode is stacked on a first side of an electrolyte layer and a cathode are stacked on a second side of an electrolyte layer, respectively. Each of the cells becomes a unit in which electricity is generated by an electrochemical reaction of a fuel and an oxidizer. Here, the fuel is supplied to the anode, and the oxidizer is supplied to the cathode.

Each of the A-type connectors 130a, 130b, 130c and 130d is integrally provided with a buffer portion for reducing an effect of a difference between thermal expansion coefficients of the cell and the support member.

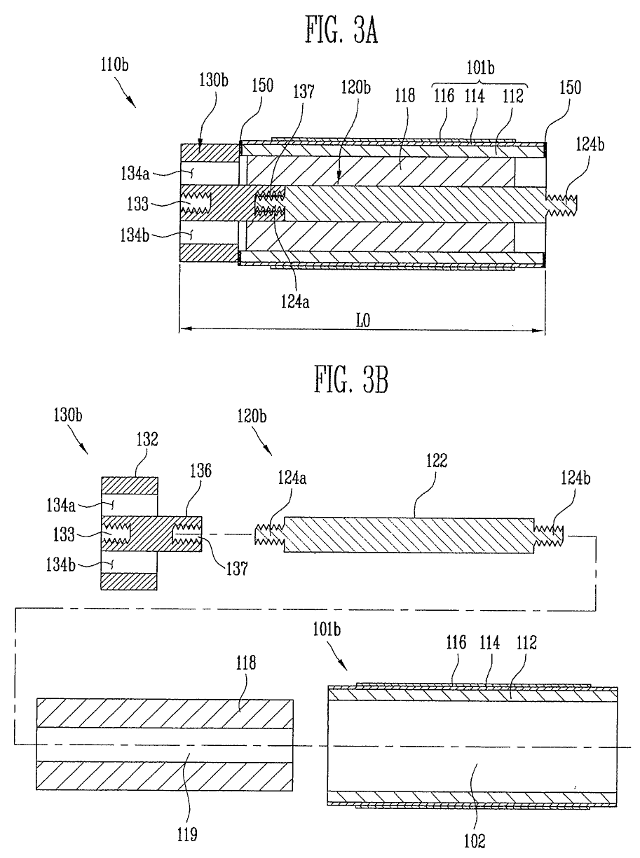

In one embodiment of the present invention, both end portions of the combined cell module 100 in its longitudinal direction are connected to first and second manifolds 140a and 140b, respectively. In this case, the first A-type connector 130a connects the first SOFC sub-cell 110 to the first manifold 140a so that a fluid can flow therethrough. The first A-type connector 130a may have a structure in which a first female screw (see 133 of FIG. 3A) is omitted or may be configured so that the hole of the first female screw is filled with a material (e.g., a predetermined material). An end connector 130e may be provided at one side of the fourth SOFC sub-cell 110d. The end connector 130e is connected to the second manifold 140b so that a fluid can flow therethrough. The end connector 130e may have a structure in which a portion (see 136 of FIG. 3B) of the A-type connector is omitted.

The combined cell module 100 has a current collecting layer 117 disposed on a second electrode 116 of each of the SOFC sub-cells 110a, 110b, 110c and 110d. In one embodiment of the present invention, as illustrated in the partially enlarged view of FIG. 2, the current collecting layer 117 is extended to cover the second electrode 116 of the first SOFC sub-cell 110a, to cover an electrolyte layer 114 exposed to one side of the second electrode 116 and to cover a portion of the A-type connector 130b in the second SOFC sub-cell 110b adjacent to the first SOFC sub-cell 110a.

In this embodiment, two adjacent sub-cells are electrically connected to each other in series by the current collecting layer 117, the conductive A-type connector 130b, a conductive porous member 118 in contact with the A-type connector 130b, an insulative sealing member 150 and the insulative A-type support member 120b. That is, the current collecting layer 117 in contact with the second electrode 116 of the first SOFC sub-cell 110a is connected to the porous member 118 of the second SOFC sub-cell 110b adjacent to the first SOFC sub-cell 110a through the A-type connector 130b, so that the combined cell module 100 has not only a physically serial connection structure but also an electrically serial connection structure.

An SOFC sub-cell (hereinafter, referred to as a sub-cell) of the combined cell module 100 according to the first embodiment of the present invention will be described in more detail with reference to FIGS. 3A to 5C.

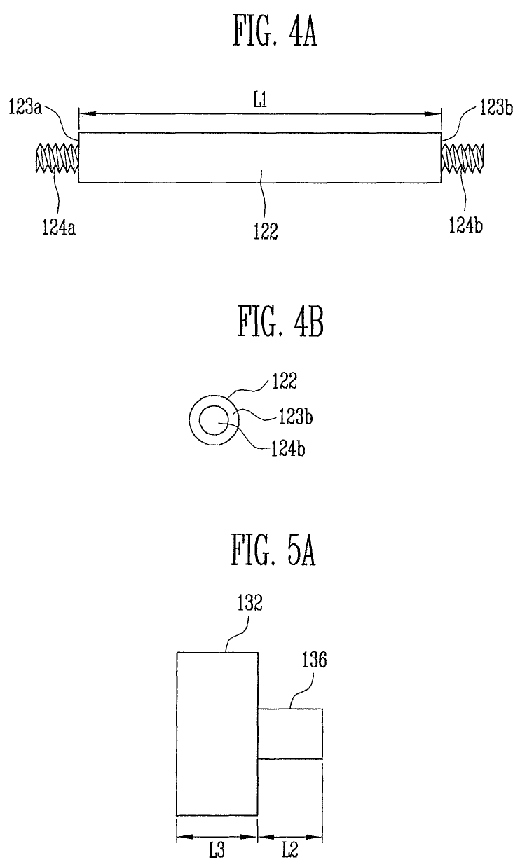

FIG. 3A is a schematic cross-sectional view of a sub-cell of the combined cell module of FIG. 2. FIG. 3B is a schematic exploded sectional view of the sub-cell of FIG. 3A. FIG. 4A is a schematic front view of an A-type support member of FIG. 3B. FIG. 4B is a schematic right side view of the A-type support member of FIG. 4A. FIG. 5A is a schematic front view of an A-type connector of FIG. 3B. FIG. 5B is a schematic left side view of the A-type connector of FIG. 5A. FIG. 5C is a schematic right side view of the A-type connector of FIG. 5A.

Referring to FIGS. 3A and 3B, the sub-cell 110b includes a tube-type cell 101b and an A-type support member 120b inserted into a hollow portion 102 of the tube-type cell 101b. The sub-cell 110b may further include a porous member 118 and a sealing member 150.

The A-type connector 130b is between two adjacent tube-type cells. However, it is described in this embodiment that the A-type connector 130b is included in the sub-cell 110b for convenience of illustration with respect to the combined cell module 100.

The tube-type cell 101b is provided with a structure in which a first electrode 112, an electrolyte layer 114, and a second electrode 116 are stacked. The electrolyte layer 114 and the second electrode 116 are sequentially stacked on the outer surface of the first electrode 112. The second electrode 116 may be formed to have a shorter length than that of the electrolyte layer 114 so that the electrolyte layer 114 is exposed at both end portions of the cell 101b in its longitudinal direction. Thus, the second electrode 116 is not electrically short-circuited with the first electrode 112.

In one embodiment, the first electrode 112 may be formed as a tube-type anode support having the hollow portion 102. A porous Ni-YSZ cermet may be used as the material of the first electrode 112. The electrolyte layer 114 may be formed of an ion conducting oxide for transporting oxygen ions, e.g., yttria stabilized zirconia (YSZ). The second electrode 116 may be formed of a porous mixed conducting oxide. The tube-type cell 101b including the first electrode 112, the electrolyte layer 114, and the second electrode 116 generates electricity and water by an electrochemical reaction of hydrogen and oxygen supplied to the first and second electrodes 112 and 116, respectively.

The A-type support member 120b is inserted into the hollow portion 102 of the tube-type cell 101b. The A-type support member 120b includes a rod-shaped body 122 of which the interior is fully filled. The A-type support member 120b further includes combining portions 124a and 124b respectively disposed at each end portion of the body 122 with stepped portions 123a and 123b interposed therebetween (see FIGS. 4A and 4B). The combining portions 124a and 124b may have the shape of a male screw having a smaller sectional area than that of the body 122. Here, the male screw has convex and concave portions spirally formed on its surface. In one embodiment, the A-type support member 120b may be formed of alumina (Al₂O₃). The thermal expansion coefficient of the alumina is about 8×10⁻⁶[K⁻¹] from room temperature to about 1000° C.

In one embodiment, the A-type connector 130b has a structure in which a shaft portion protrudes from a central portion at one side of a wheel-shaped body 132. That is, the A-type connector 130b includes: a first female screw 133 formed inside the central portion of a first surface of the body 132; a plurality of openings 134a, 134b, 134c, and 134d, formed around the first female screw 133 to pass through the body 132; and a coupling portion 136 protrudes outside from the central portion of a second surface opposite to the first surface of the body 132 (see FIGS. 5A to 5C).

The coupling portion 136 is integrally provided with the A-type connector 130b and has a sectional area and a sectional shape, similar to those of the A-type support member 120b. A second female screw 137 is provided at a central portion of the coupling portion 136 so that the first and second female screws 133 and 137 face each other. The second female screw 137 of the A-type connector 130b is screw-connected to the combining portion 124a at one side of the A-type support member 120b.

In one embodiment, the A-type connector 130b may be formed of ferrite stainless steel. The thermal expansion coefficient of the ferrite stainless steel is about 13×10⁻⁶[K⁻¹] from room temperature to about 1000° C.

The length L2 (see FIG. 5A) of the coupling portion 136 is appropriately controlled depending on a difference between thermal expansion coefficients of the cell 101b and the A-type support member 120b. In one embodiment, the ratio of the length L2 of the coupling portion to the length L1 of the A-type support member (see FIG. 4A) is configured so that the thermal expansion coefficient of the combined structure of the coupling portion 136 and the A-type support member 120b is 95 to 105%. For example, the length L1 (see FIG. 4A) of the A-type support member 120b may be about 80% and the length L2 of the coupling portion 136 may be about 20% with respect to the length obtained by roughly subtracting the length L3 (see FIG. 5A) of the body 132 of the A-type connector 130b from the length L0 (see FIG. 3A) of the sub-cell 110b. In this case, the thermal expansion coefficient of the combined structure of the A-type support member 120b and the coupling portion 136 is about 9×10⁻⁶[K⁻¹] from room temperature to about 1000° C.

If the length L2 of the coupling portion 136 is controlled, i.e., if the ratio of the lengths L1 and L2 of the A-type support member 120b and the coupling portion 136 is controlled, it is possible to reduce or prevent undesired thermal stress from being generated from the combined cell module 100 due to the difference of thermal expansion coefficients between the cells and the support members.

Referring back to FIGS. 3A and 3B, the porous member 118 may be provided between the first electrode 112 and the A-type support member 120b in the sub-cell 110b. The porous member 118 may be formed in the shape of a pipe having a hollow portion 119 by appropriately pressurizing a flexible member. The material of the porous member 118 may include a metal felt such as a nickel felt and a metal mesh having a similar shape to the metal felt. The porous member 118 may have a conducting property (e.g., be formed of an electrically conducting material, such as metal).

The sealing member 150 is provided at a boundary portion between the cell 101b and the A-type connector 130b. The sealing member 150 may be provided at both end portions of the sub-cell 110b in its longitudinal direction. In one embodiment, the sealing member 150 is formed of a material having a high sealing performance when pressure stress is generated in the A-type support member 120b and the cell 101b in operation of the combined cell module 100. The material of the sealing member 150 may include a Mica-based material and/or Thermiculite (product name). If the sealing member 150 is used, a manufacturing process can be simplified as compared with a sealing process using a brazing technique, and impurity mixture can be reduced as compared with a glass-type sealing process.

Hereinafter, the process of manufacturing the combined cell module 100 of the first embodiment will be described in more detail.

First, an yttria-stabilized zirconia (YSZ) powder mixed with 40 vol % nickel (Ni), available for an anode electrode material, is kneaded by adding activated carbon, organic binder and water to the YSZ powder, and the kneaded slurry is extrusion-molded. After drying the extrusion-molded slurry, an anode support tube is prepared by sintering the dried slurry at about 1300° C.

Subsequently, the YSZ powder that is an electrolyte material is prepared as an electrolyte slurry, and the electrolyte slurry is then dip-coated on the anode support tube using a slurry coating technique. The electrolyte slurry coated on the anode support tube is dried at a room temperature and then sintered at about 1400° C.

Subsequently, a (La,Sr)MnO3 (LSM) powder available for a cathode material is prepared as a cathode slurry, and the cathode slurry is then dip-coated on the electrolyte layer of the anode support tube. The cathode slurry coated on the electrolyte layer of the anode support tube is dried and then sintered at about 1200° C.

The manufactured SOFC cell has an outer diameter of about 20 mm, an inner diameter of about 16 mm and a length of about 300 mm.

Subsequently, a nickel felt is inserted into the manufactured SOFC cell. Then, the A-type support member formed of alumina and the A-type connector formed of stainless steed are prepared, and the combining portion 124a at one side of the A-type support member is screw-connected to a second female screw 137 of the A-type connector.

Subsequently, the A-type support member having the A-type connector combined at one side thereof is inserted in a hollow portion of the cell into which the nickel felt is inserted from the other side opposite to the one side of the A-type support member. In another embodiment of the present invention, the A-type support member having the A-type connector combined at one side thereof may be inserted together with the nickel felt into the hollow portion of the cell while having been previously inserted into a hollow portion of the nickel felt.

Subsequently, a plurality of sub-cells are prepared in which the nickel felt and the A-type support member are inserted, and the A-type connector is connected to one side of the A-type support member. The prepared sub-cells are screw-connected to one another in a longitudinal direction thereof.

Subsequently, boundary portions between the cells and the A-type support members are sealed with a sealing member 150. Thermiculite #866 (product name) may be used as the sealing member 150.

Subsequently, the current collecting layer 117 is formed by coating a La_{0.9}Sr_{0.1}CoO₃ powder available for a cathode current collecting material on the second electrode 116 of each of the sub-cells using a plasma spray technique. The current collecting layer 117 is formed to cover the second electrode 116 of the first sub-cell (e.g., 110a), the electrolyte layer 114 exposed to one side of the second electrode 116, and a portion of the A-type connector (e.g., 130b) between the first sub-cell and the second sub-cell (e.g., 110b) adjacent to the first sub-cell.

Hereinafter, the operation of the combined cell module 100 of the first embodiment will be described in more detail.

In FIG. 2, a black arrow 141 indicate the flow direction of a fuel, and a white arrow 143 indicate the flow direction of an oxide. The fuel may include methane, propane, butane and/or the like. The oxidizer may include air, oxygen, gas, and/or the like.

The fuel flows from the first manifold 140a to the hollow portion at one side of the combined cell module 100 flows along the outer surfaces of the A-type support members 120a to 120d. At this time, the fuel passes through the A-type connectors 130a to 130d, openings at the end connector 130e, and the porous member 118 between the openings. Most of the fuel that flows into the combined cell module 100 is converted into a reformate gas containing abundant hydrogen under a high-temperature atmosphere. The hydrogen is supplied to the first electrode of each of the sub-cells while moving along the flow direction of the fuel.

The combined cell module 100 generates electric energy and water by an electrochemical reaction of oxygen in the air and hydrogen. Here, the oxygen is supplied to the second electrode 116, and the hydrogen is supplied to the first electrode 112. The electric energy is supplied to an external circuit or load connected to the combined cell module 100. A reaction byproduct, such as water, and an unreacted fuel are moved along the flow direction of the fuel on the outer surface of the rod-shaped A-type support member and then discharged to the second manifold 140b connected to the other side of the combined cell module 100.

The electrochemical reaction respectively generated at the first and second electrodes (anode and cathode) of each of the sub-cells are represented by the following reaction formula 1.

$$Anode : {H}^{2} + {O}^{2 -} -> {H}_{2} O + 2 {e}^{-} \\ Cathode : \frac{1}{2} {O}_{2} + 2 {e}^{-} -> {O}^{2 -} \qquad [ Reaction formula 1 ]$$

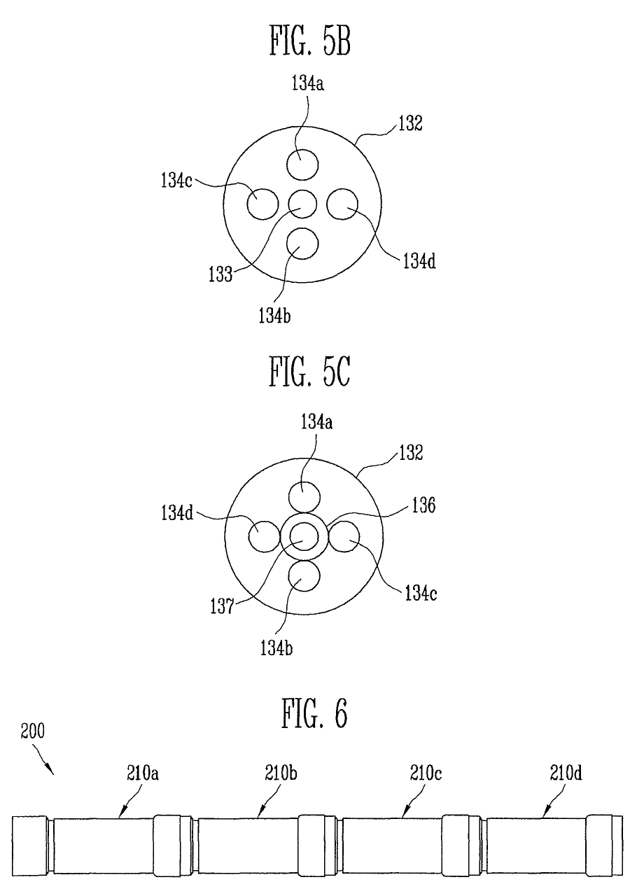

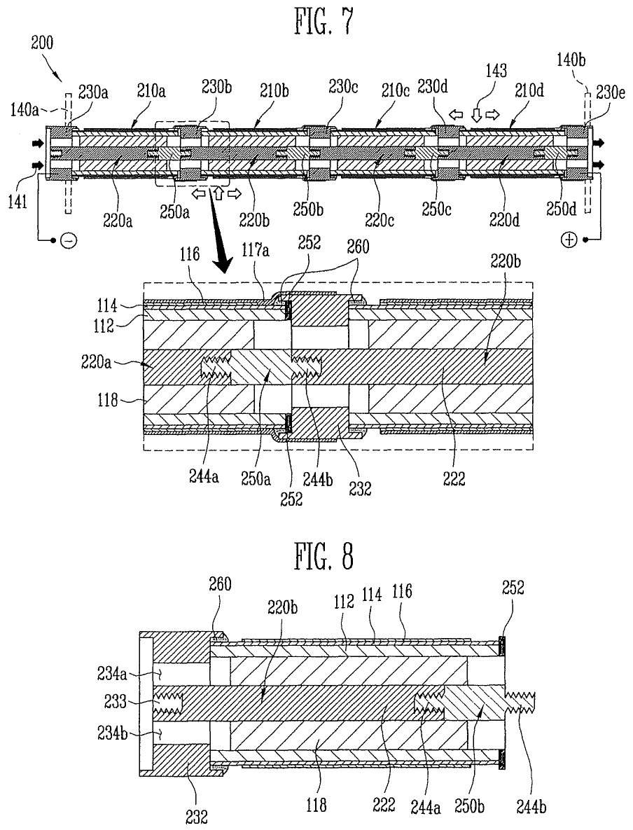

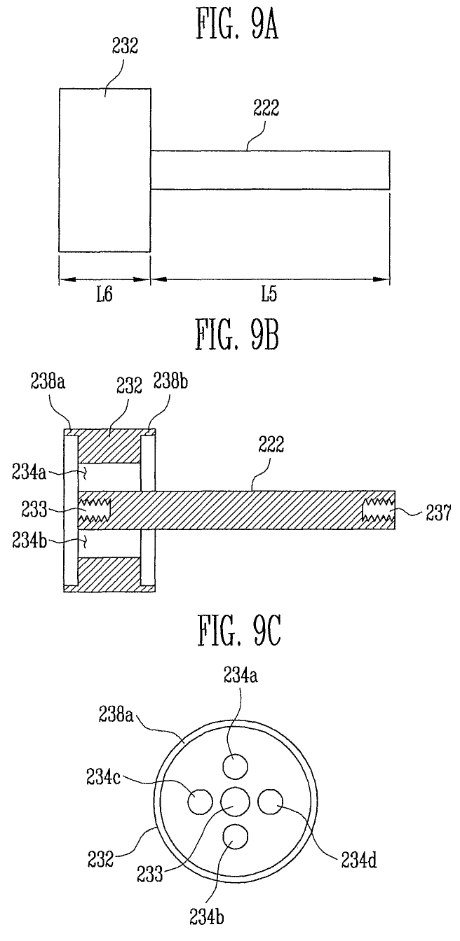

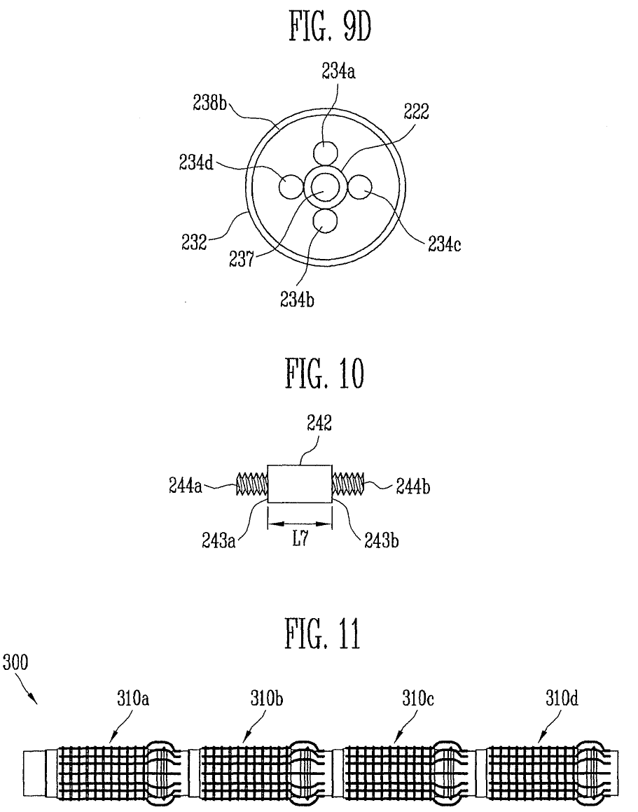

FIG. 6 is a schematic front view of a combined cell module according to a second embodiment of the present invention. FIG. 7 is a schematic cross-sectional view of the combined cell module according to the second embodiment. FIG. 8 is a schematic cross-sectional view of a sub-cell of the combined cell module of FIG. 7. FIG. 9A is a schematic front view of a support member integrated with a connector (hereinafter, referred to as a B-type support member), used in the combined cell module of FIG. 7. FIG. 9B is a schematic longitudinal cross-sectional view of the B-type support member of FIG. 9A. FIG. 9C is a schematic left side view of the B-type support member of FIG. 9A. FIG. 9D is a schematic right side view of the B-type support member of FIG. 9A. FIG. 10 is a schematic front view of a coupling portion (hereinafter, referred to as a B-type coupling portion) used in the combined cell module of FIG. 7.

Referring to FIGS. 6 to 8, the combined cell module 200 includes a plurality of sub-cells 210a, 210b, 210c and 210d. Each of the sub-cells includes a plurality of cells and B-type support members 220a, 220b, 220c and 220d each having a portion inserted into a hollow portion of each of the cells in its longitudinal direction. Connectors 230a, 230b, 230c and 230d are integrally provided at one side of the respective B-type support members. The combined cell module 200 further includes B-type coupling portions 250a, 250b, 250c and 250d between two adjacent sub-cells and between a sub-cell positioned at one end of the combined cell module 200 and an end connector 230e. The end connector 230e is provided between one end of the combined cell module 200 and a manifold 140b.

Each of the sub-cells 210a, 210b, 210c and 210d includes a first electrode 112 for forming a tube-type support, and an electrolyte layer 114 and a second electrode 116, sequentially stacked on the outer surface of the first electrode 112.

The B-type support members 220a, 220b, 220c and 220d are physically connected while being electrically isolated from one another. The B-type support members 220a, 220b, 220c and 220d are serially located from one end to the other end of the combined cell module 200. In one embodiment, as illustrated in FIGS. 9A to 9D, each of the B-type support members has a structure in which a long handle is attached to a central portion of one side of a wheel-shaped body 232. That is, each of the B-type support members includes a first female screw 233 formed in an interior of the central portion at one side of the body 232, a plurality of openings 234a, 234b, 234c and 234d passing through the body 232 in one direction (e.g., a longitudinal direction) around the first female screw 233, and a support portion 222 extending in a longitudinal direction to the exterior from the central portion of the other side of the body 232 while facing the first female screw 233. A second female screw 237 is formed at the end of the support portion 222, extending to the exterior. Flanges 238a and 238b are respectively formed at first and second ends of the body 232 to slightly protrude in the longitudinal direction.

The B-type coupling portions 250a, 250b, 250c and 250d have a thermal expansion coefficient different from that of the B-type support members, and are between the B-type support members. In one embodiment, each of the B-type coupling portions 250a, 250b, 250c and 250d has the shape of a double male screw as illustrated in FIG. 10. That is, each of the B-type coupling portions includes a short cylindrical body 242, and first and second male screws 244a and 244b respectively extending by a length (e.g., a predetermined length) to the exterior from both end portions of the body 242 with stepped portions interposed therebetween. Here, the sectional area of each of the first and second male screws 244a and 244b is smaller than that of the body 242.

In this embodiment, the B-type support member may be formed of ferrite stainless steel, and the B-type coupling portion may be formed of alumina (Al₂O₃). In this case, the length of the B-type coupling portion and the length of the support portion of the B-type support member are controlled by considering the thermal expansion coefficient of the tube-type cell constituting the sub-cell, thereby reducing the effect of the difference between thermal expansion coefficients of components of the combined cell module 200. For example, it is assumed that the length L5 (see FIG. 9A) of the support portion 222 of the B-type support member is about 80% and the length L7 (see FIG. 10) of the body 242 of the B-type coupling portion is about 20%, based on the length of the sub-cell or tube-type cell. Then, the thermal expansion coefficient of the combined structure of two components becomes about 12×10⁻⁶[K⁻¹] from room temperature to about 1000° C.

Referring back to FIGS. 7 and 8, in one embodiment, a porous member 118 is between the first electrode 112 and the support portion 222 of each of the B-type support members 220a, 220b, 220c and 220d in the SOFC combined cell module 200. The porous member 118 is flexible and is filled in the space between the first electrode 112 and the support portion 222 in the sub-cell. The porous member 118 (e.g., formed of a metal) has a conductive property, and connects the first electrode 112 and the support portion 222 in the sub-cell.

In one embodiment, an insulating member 252 is provided between adjacent sub-cells. That is, the insulating member 252 allows the first electrode 112 of the first sub-cell 210a to be electrically insulated from the connector 230b of the second sub-cell 210. One side of the insulating member 252 may be supported by a flange portion of the connector 230b.

In one embodiment, boundary portions between the sub-cells 210a, 210b, 210c and 210d and between the cell of each of the sub-cells and the connector may be sealed with a sealing member 260. The sealing member 260 may be formed by melting BNi-2 (Cr 7%, B 3%, Si 4.5%, Fe 3%, C 0.05%, Ni Bal.) available for a Ni-based brazing material using an induction brazing technique.

A current collecting layer 117a is provided on the second electrode 116 of each of the sub-cells. In one embodiment, the current collecting layer 117a may be consecutively formed on the second electrode 116, the electrolyte layer 114 exposed to one side of the second electrode 116, and a portion of the connector of the B-type support member adjacent to the electrolyte layer 114.

In the combined cell module 200, the current collecting layer 117a connected to the second electrode 116 of the first sub-cell (e.g., 210a) is connected to the first electrode 112 of the second sub-cell (e.g., 210b) through the B-type support member 220b of the second sub-cell 210b. Thus, the electrical serial connection structure of the sub-cells can be stably formed, in addition to the mechanical serial connection structure of the sub-cells.

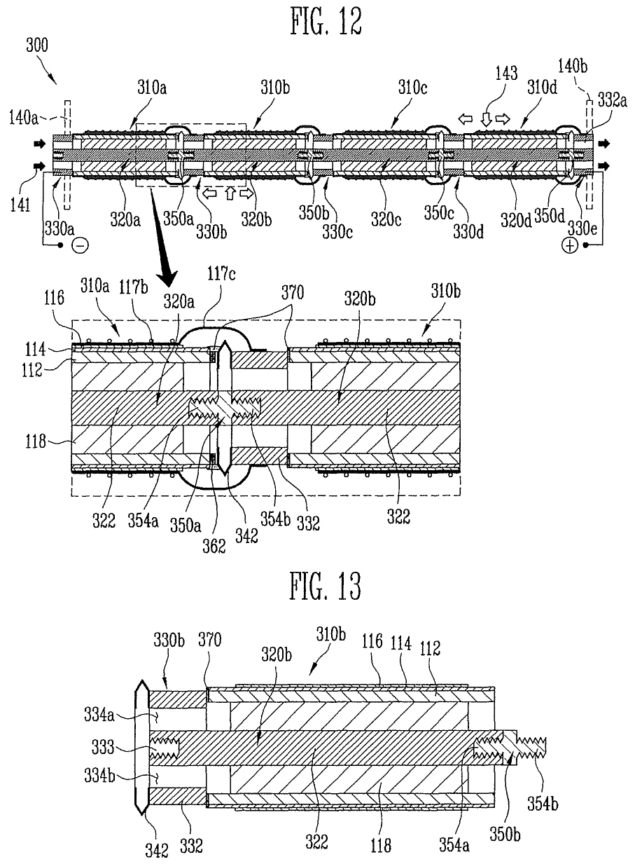

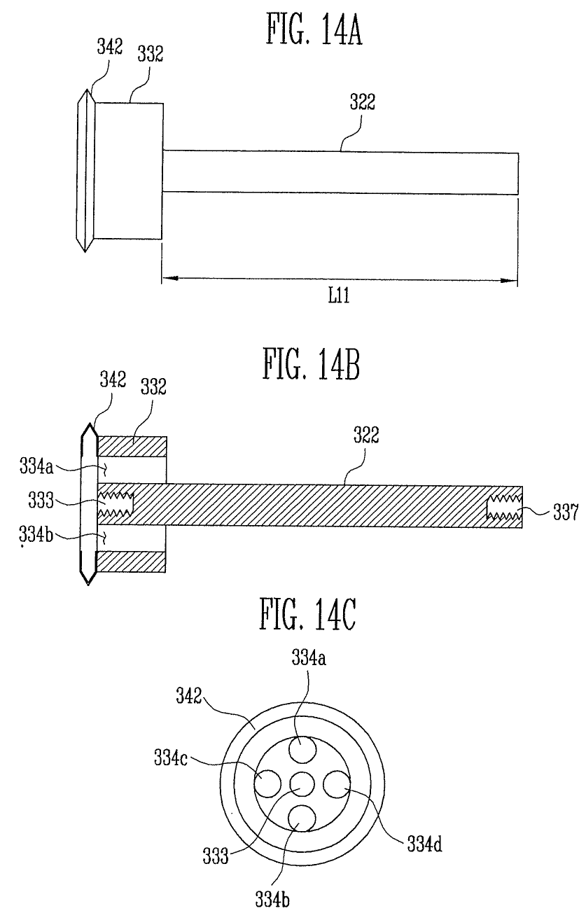

FIG. 11 is a schematic front view of a combined cell module according to a third embodiment of the present invention. FIG. 12 is a schematic cross-sectional view of the combined cell module according to the third embodiment of the present invention. FIG. 13 is a schematic cross-sectional view of a sub-cell of the combined cell module of FIG. 12. FIG. 14A is a schematic front view of a support member integrated with a connector and a resilient portion (hereinafter, referred to as a C-type support member), used in the combined cell module of FIG. 12. FIG. 14B is a schematic longitudinal cross-sectional view of the C-type support member of FIG. 14A. FIG. 14C is a schematic left side view of the C-type support member of FIG. 14A. FIG. 14D is a schematic right side view of the C-type support member of FIG. 14A. FIG. 15 is a schematic front view a coupling member (hereinafter, referred to as a C-type coupling member) applicable to the combined cell module of FIG. 12.

Referring to FIGS. 11 to 13, the combined cell module 300 includes a plurality of sub-cells 310a, 310b, 310c and 310d. Each of the sub-cells includes a plurality of cells and C-type support members 320a, 320b, 320c and 320d each having a portion inserted into a hollow portion of each of the cells in its longitudinal direction. Connectors 330a, 330b, 330c and 330d are integrally provided at one side of the respective C-type support members. The combined cell module 300 further includes C-type coupling portions 350a, 350b, 350c and 350d disposed between two adjacent C-type support members and between a sub-cell positioned at one end of the combined cell module 300 and an end connector 330e. The end connector 330e connects the one end of the combined cells module 300 to a manifold 140b so that a fluid can flow therethrough.

Each of the sub-cells 310a, 310b, 310c and 310d includes a first electrode 112 for forming a tube-type support, and an electrolyte layer 114 and a second electrode 116, sequentially sacked on the outer surface of the first electrode 112.

The C-type support members 320a, 320b, 320c and 320d are physically connected together with the C-type coupling members 350a, 350b, 350c and 350d while being electrically isolated from one another by the C-type coupling members. The C-type support members 320a, 320b, 320c and 320d are serially located from one end to the other end of the combined cell module 300. Here, it can be seen that each of the C-type coupling members serves as a kind of insulating member.

In one embodiment, as illustrated in FIGS. 14A to 14D, each of the C-type support members 320a, 320b, 320c and 320d has a structure in which a support portion with a long hand shape is attached to a central portion of one side of a wheel-shaped body 332, and a resilient portion 342 is integrally formed at an edge of the other side of the body 332. Here, the body corresponds to each of the connectors 330a, 330b, 330c and 330d.

Each of the C-type support members includes a first female screw 333 formed in an interior of the central portion at one side of the body 332, a plurality of openings 334a, 334b, 334c and 334d passing through the body 332 in one direction (e.g., a longitudinal direction) around the first female screw 333, and a support portion 322 extending longitudinally to the exterior from the central portion of the other side of the body 332 while facing the first female screw 333. A second female screw 337 is formed at an end of the support portion 322 to face the first female screw 333.

The resilient portion 342 has an expanding and contracting structure and is integrally connected to an edge of one side surface of the body 332 of the C-type support member at which the first female screw 333 is positioned. The resilient portion 342 is resiliently contracted or expanded slightly between the sub-cells when pressure stress is generated between the sub-cells and the C-type support members.

The C-type coupling portions 350a, 350b, 350c and 350d have an insulating property. Each of the C-type coupling portions 350a, 350b, 350c and 350d has a sectional area and a sectional shape, similar (or identical) to that of the support portion 322 of the C-type support member. The C-type coupling portions 350a, 350b, 350c and 350d are between the C-type support members. Each of the C-type coupling portions 350a, 350b, 350c and 350d has the shape of a double male screw as illustrated in FIG. 15. That is, each of the C-type coupling portions includes a flat cylindrical body 342, and first and second male screws 344a and 344b respectively extending by a length (e.g., a predetermined length) to the exterior from central portions at first and second sides of the body 342 with stepped portions 343a, 343b interposed therebetween. Here, the sectional area of each of the first and second male screws 344a and 344b is smaller than that of the body 342. The length of the C-type coupling portion may be shorter than that of the B-type coupling portion of FIG. 10.

In this embodiment, the C-type support member may be formed of ferrite stainless steel, and the C-type coupling portion may be formed of alumina (Al₂O₃). In this case, the length L12 (see FIG. 15) of the C-type coupling portion may be appropriately controlled considering the thermal expansion coefficient of the tube-type cell constituting the sub-cell. That is, the ratio of the length L11 (see FIG. 14A) of the support portion of the C-type support member to the length L12 of the C-type coupling portion is controlled, thereby reducing or preventing undesired thermal stress from being generated due to the difference of thermal expansion coefficients between components of the combined cell module 300.

For example, it is assumed that the length L11 of the support portion 322 of the C-type support member is about 95% and the length L12 of the body 342 of the C-type coupling portion is about 5%, based on the length of the sub-cell. Then, the thermal expansion coefficient of the combined structure of two components becomes about 10×10⁻⁶[K⁻¹] from room temperature to about 1000° C. That is, if the ratio of the lengths L11 and L12 of the two combined components is controlled, the thermal expansion coefficient of the combined structures of the C-type support members and the C-type coupling portions is substantially identical to or slightly smaller than that of the tube-type cells, thereby reducing thermal stress from being generated due to the difference of thermal expansion coefficients.

Referring back to FIGS. 12 and 13, the first C-type support member 320a positioned at one end portion of the combined cell module 300 may be provided with a structure in which a resilient portion is omitted, which is slightly different from the second C-type support member 320b. The connector 330a of the first C-type support member 320a connects one end of the combined cell module 300 to the first manifold 140a so that a fluid can flow therethrough. The end connector 330e may have a similar shape to that of the body 332 of the C-type support member. The end connector 330e allows the other end of the combined cell module 300 to be fixedly connected to the second manifold 140b with the fourth C-type coupling member 350d interposed therebetween.

In one embodiment of the present invention, a porous member 118 is provided between the first electrode 112 and the support portion 322 of each of the C-type support members 320a, 320b, 320c and 320d in the combined cell module 300.

In one embodiment of the present invention, an insulating member 362 is provided between adjacent sub-cells, i.e., a specific sub-cell (e.g., 310a) and another sub-cell (e.g., 310b) adjacent to the specific sub-cell. The insulating member 362 electrically insulates the first electrode 112 in the first sub-cell 310a from the resilient portion 342 of the C-type support member 320b in the second sub-cell 310b.

In one embodiment of the present invention, boundary portions between the sub-cells 310a, 310b, 310c and 310d and between the tube-type cell and the connector in each of the sub-cells may be sealed with a sealing member 370. The sealing member 370 may be formed to cover the insulating member 362 between two adjacent sub-cells. The sealing member 370 may be formed of a sealing material including glass based, crystallized glass based, MICA, MICA-glass composite, glass-filler composite and the like.

A current collecting layer 117b is provided on the second electrode 116 of each of the sub-cells 310a, 310b, 310c and 310d. The current collecting layer 117b may be formed of stainless steel, Ni-based thermal resistance alloy containing silver (Ag). In this embodiment, the current collecting layer 117b is formed using a conductive mesh. In another embodiment of the present invention, the current collecting layer 117b may be formed by winding a conductive wire on the second electrode 116. In this case, the current collecting layer 117b may be welded to the conductive body 332 of the C-type support member using a spot-welding technique. In still another embodiment of the present invention, the current collecting layer 117b may be formed by coating a conductive oxide such as LaCoO₃.

In the combined cell module 300, the current collecting layer 117b connected to the second electrode 116 of the first sub-cell (e.g., 310a) is connected to the first electrode 112 of the second sub-cell (e.g., 310b) through the C-type support member 320b of the second sub-cell. In the enlarged view of FIG. 12, the current collecting layer 117b is connected to the connector 330b of the C-type support member 230b by a wire or interconnection 117c.

According to the aforementioned embodiment, the electrical serial connection structure of the sub-cells can be stably formed as well as the physical serial connection structure of the sub-cells. That is, two or more anode supported cells are physically and electrically connected in series, so that a combined cell module having excellent durability can be easily manufactured.

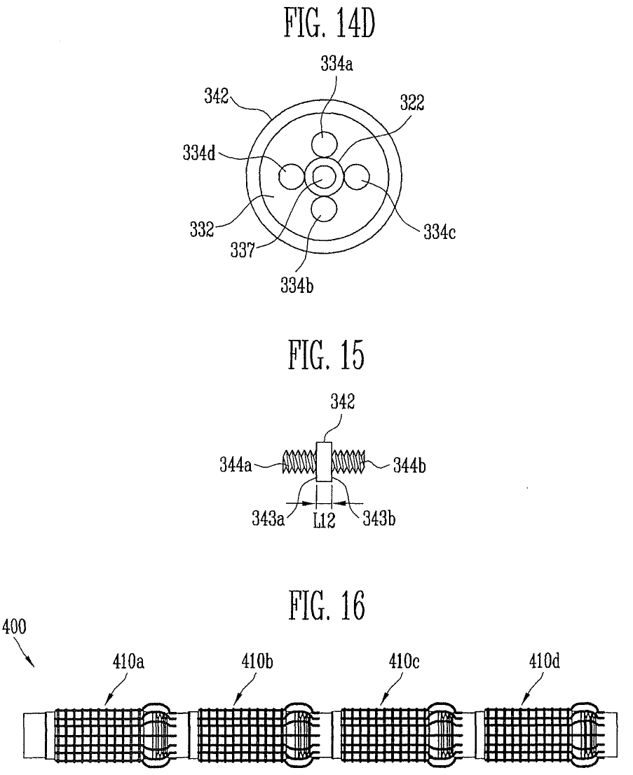

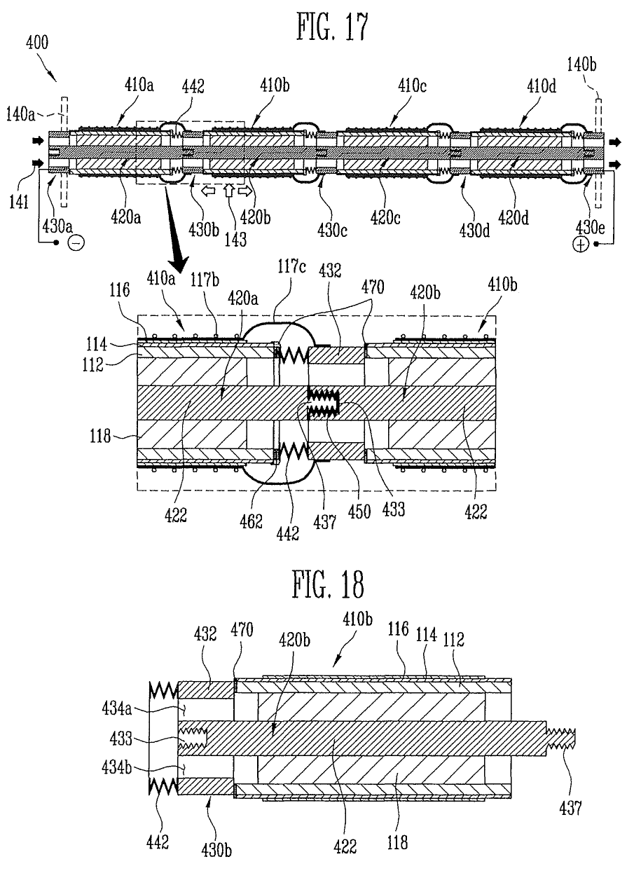

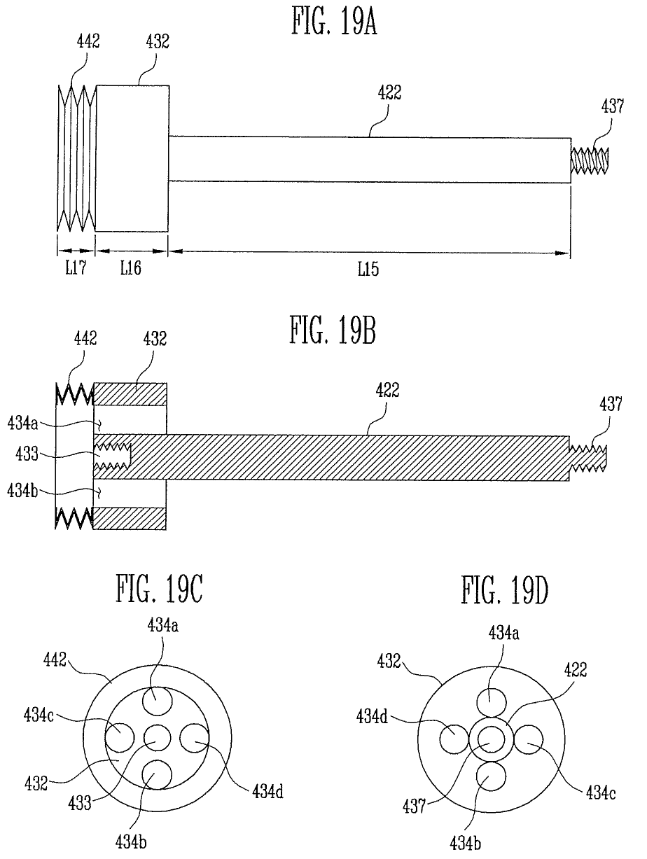

FIG. 16 is a schematic front view of a combined cell module according to a fourth embodiment of the present invention. FIG. 17 is a schematic cross-sectional view of the combined cell module according to the fourth embodiment of the present invention. FIG. 18 is a schematic cross-sectional view of a sub-cell of the combined cell module of FIG. 17. FIG. 19A is a schematic front view of a support member integrated with a connector and a resilient portion (hereinafter, referred to as a D-type support member), used in the combined cell module of FIG. 17. FIG. 19B is a schematic longitudinal cross-sectional view of the D-type support member of FIG. 19A. FIG. 19C is a schematic left side view of the D-type support member of FIG. 19A. FIG. 19D is a schematic right side view of the D-type support member of FIG. 19A.

Referring to FIGS. 16 to 18, the combined cell module includes a plurality of sub-cells 410a, 410b, 410c and 410d. Each of the sub-cells includes a plurality of cells and D-type support members 420a, 420b, 420c and 420d each having a portion inserted into a hollow portion of each of the cells in its longitudinal direction. Connectors 430a, 430b, 430c and 430d are integrally provided at one side of the respective D-type support members. The combined cell module 400 further includes insulating members 450 each being between two adjacent D-type support members or between a sub-cell positioned at one end of the combined cell module 400 and an end connector 430e. The end connector 430e connects the one end of the combined cells module 400 to a manifold 140b so that a fluid can flow therethrough.

Each of the sub-cells 410a, 410b, 410c and 410d includes a first electrode 112 for forming a tube-type support, and an electrolyte layer 114 and a second electrode 116, sequentially sacked on the outer surface of the first electrode 112.

The D-type support members 420a, 420b, 420c and 420d are physically connected to one another while being electrically isolated from one another by the insulating members 450. The B-type support members 420a, 420b, 420c and 420d are serially located from one end to the other end of the combined cell module 400.

In one embodiment, each of the D-type support members 420a, 420b, 420c and 420d has a hammer shape as illustrated in FIGS. 19A to 19D. That is, each of the D-type support members includes a body 432 corresponding to a head portion, a support portion 422 extending longitudinally in a rod shape from a central portion of one side of the body 432, and a resilient portion 442 at an end of the other side of the body 432, which are integrally combined with one another. Each of the D-type support members further includes a first female screw 433 formed inside a central portion of one side of the body 432, a plurality of openings 434a, 434b, 434c and 434d passing through the body 432 in one direction (e.g., a longitudinal direction) around the first female screw 433, and a male screw 437 formed from an end portion of the support member 422 to the exterior of the support member 422 while facing the first female screw 433.

The resilient member 442 has an expanding and contracting structure and is integrally connected to an edge of one side surface of the body 432 of the C-type support member, at which the first female screw 433 is positioned. The resilient portion 442 is resiliently contracted or expanded between the sub-cells when pressure stress is generated between the sub-cells and the C-type support members.

The resilient member 442 of this embodiment is formed to have a higher elastic modulus than that of the resilient portion 342 of FIG. 13. Therefore, in the combined cell module 400 of this embodiment, the C-type coupling portions 350a, 350b, 350c and 350d of FIG. 12 may be substantially omitted. However, an insulating member 450 is provided between the D-type support members for the purpose of electrical isolation between the D-type support members. The insulating member 450 may be formed as an insulating coating layer.

In this embodiment, the D-type support member may be formed of ferrite stainless steel. In this case, the elastic force of the resilient portion may be appropriately controlled considering the difference of thermal expansion coefficients between the tube-type cell constituting the sub-cell and the D-type support member. That is, the elastic force of the resilient portion 442 is appropriately controlled, thereby reducing thermal stress generated due to the difference of thermal expansion coefficients between components of the combined cell module 400.

Referring back to FIGS. 17 and 18, the first D-type support member 420a positioned at one end portion of the combined cell module 400 may have a structure in which a resilient portion is omitted, which is slightly different from the second D-type support member 420b. The connector 430a of the first D-type support member 420a connects one end of the combined cell module 400 to a manifold 140a so that a fluid can flow therethrough. The end connector 430e may have a similar shape to that of the body 432 of the D-type support member integrally provided with the resilient portion. The end connector 430e connects the other end of the combined cell module 400 to another manifold 140b so that a fluid can flow therethrough.

In one embodiment of the present invention, a porous member 118 may be provided between the first electrode 112 and the support portion 422 of each of the D-type support members 420a, 420b, 420c and 420d in each of the sub-cells constituting the combined cell module 400.

In one embodiment of the present invention, another insulating member 462 (hereinafter, referred to as a second insulating member) may be provided between adjacent sub-cells, i.e., between a specific sub-cell (e.g., 410a) and another sub-cell (e.g., 410b) adjacent to the specific sub-cell. The second insulating member 462 insulates the first electrode 112 of the first sub-cell 410a from the resilient portion 442 of the D-type support member 420b in the second sub-cell 410b.

In one embodiment of the present invention, boundary portions between the sub-cells 410a, 410b, 410c and 410d and between the tube-type cell and the connector in each of the sub-cells may be sealed with a sealing member 470. The sealing member 470 may be formed to cover the second insulating member 462 between two adjacent sub-cells. The sealing member 470 may be formed of a sealing material including glass based, crystallized glass based, MICA, MICA-glass composite, glass-filler composite and the like.

A current collecting layer 117b is provided on the second electrode 116 of each of the sub-cells 410a, 410b, 410c and 410d. The current collecting layer 117b may be formed of stainless steel, Ni-based thermal resistance alloy containing silver (Ag). In this embodiment, the current collecting layer 117b is formed using a conductive mesh. The current collecting layer 117b is connected to the conductive body 432 of the D-type support member through a conducting wire 117c. The conducting wire 117c may be welded to the conductive body 432 using a spot-welding technique.

In the combined cell module 400, the current collecting layer 117b connected to the second electrode 116 of the first sub-cell (e.g., 410a) is connected to the first electrode 112 of the second sub-cell (e.g., 410b) through the D-type support member 420b of the second sub-cell adjacent to the first sub-cell. Thus, the electrical serial connection structure of the sub-cells can be stably formed as well as the mechanical serial connection structure of the sub-cells.

In the aforementioned embodiment, the plurality of sub-cells are configured as anode supported cells. However, it will be apparent through the aforementioned disclosure that the sub-cells of these embodiments can be configured using anode supported cells, cathode supported cells, segmented in series cells or combination thereof.

According to the aforementioned embodiments, a plurality of tube-type anode supported SOFC cells are connected to one another in their longitudinal direction using a solid support member, thereby easily manufacturing a combined cell module for a solid oxide fuel cell having a desired length, e.g., at least about 1200 mm.

Further, in a serial connection structure of tube-type anode supported SOFC cells, the serial connection structure of SOFC cells can be mechanically and stably supported using support members, and by using a buffer portion, it is possible to prevent a device from being damaged (or reduce the likelihood of the device being damaged) due to the thermal stress generated by the difference of thermal expansion coefficients between components.

Further, since the connection between a combined cell module and a manifold is reinforced by the support members, it is possible to prevent a device from being broken (or reduce the likelihood of the device being broken) due to the mechanical stress generated in the combined cell module for a solid oxide fuel cell and a connecting portion of the manifold.

Further, in a single combined cell module provided with a plurality of anode supported SOFC cells, the electrical serial connection structure between the SOFC cells and the current collecting structure can be easily formed.

Further, a large-size SOFC system can be effectively designed and manufactured using a combined cell module provided with a plurality of anode supported SOFC cells.

While aspects of the present invention have been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A combined cell module for a solid oxide fuel cell, comprising:
a first sub-cell;
a second sub-cell;
a connector between the first and second sub-cells,
each of the first and second sub-cells having a hollow portion extending along its length direction, each of the first and second sub-cells comprising:
a first electrode;
a second electrode;
an electrolyte layer between the first and second electrodes; and
a support member extending along the length direction within the hollow portion,
the support members of the first and second sub-cells being physically coupled to each other via the connector, and
at least one of the first electrode or the second electrode of the first sub-cell being electrically coupled to at least one of the first electrode or the second electrode of the second sub-cell via the connector.

2. The combined cell module of claim 1, wherein the second electrode of the first sub-cell is electrically coupled in series to the first electrode of the second sub-cell via the connector.

3. The combined cell module of claim 2, further comprising an insulating sealing member between the connector and the first sub-cell and configured to electrically insulate the first electrode of the first sub-cell from the first electrode of the second-sub cell.

4. The combined cell module of claim 1, wherein the support members of the first and second sub-cells are screw coupled to each other via the connector at the central axis of the combined cell module.

5. The combined cell module of claim 1, wherein the connector comprises a body having at least one through-hole opening configured to allow a fluid to flow between the first sub-cell and the second sub-cell.

6. The combined cell module of claim 5, wherein the at least one through-hole opening comprises a plurality of through-hole openings around the central axis of the combined cell module.

7. The combined cell module of claim 1, wherein the connector comprises a body and a coupling portion protruding from the body, the coupling portion being configured to couple the connector to the support member of at least one of the first sub-cell or the second sub-cell.

8. The combined cell module of claim 7, wherein the coupling portion has a screw thread and wherein the support member of at least one of the first sub-cell or the second sub-cell has a corresponding screw thread at an end thereof and configured to engage with the screw thread of the coupling portion.

9. The combined cell module of claim 8, wherein the screw thread of the support member is a male screw thread and wherein the screw thread of the coupling portion is a female screw thread.

10. The combined cell module of claim 7, wherein the support member has a screw thread at each end thereof to enable the support member to be connected between the connector and another connector and wherein the coupling portion of the connector has a screw thread at each end thereof to enable the connector to be connected between the support members of the first and second sub-cells.

11. The combined cell module of claim 1, wherein the connector is integrally provided with the support member of the second sub-cell.

12. The combined cell module of claim 11, wherein the support member has a first screw thread, wherein the connector has a second screw thread, and wherein the first screw thread of the support member of the first sub-cell is configured to be screwed into the second screw thread of the connector.

13. The combined cell module of claim 11, further comprising a coupling portion configured to couple the support member of the first sub-cell to the connector.

14. The combined cell module of claim 13, wherein the coupling portion has a double male-ended screw thread configured for insertion into a female screw thread of the connector and a female screw thread of the support member of the first sub-cell.

15. The combined cell module of claim 1, further comprising a current collecting layer on the second electrode, on the electrolyte layer and on the connector.

16. The combined cell module of claim 15, further comprising a conducting porous member within the hollow portion, wherein the porous member is between the first electrode and the support member, and the current collecting layer of the first sub-cell is in contact with the conducting porous member of the second sub-cell between the first electrode of the second sub-cell and the support member of the second sub-cell.

17. The combined cell module of claim 1, further comprising a resilient portion, wherein the connector comprises a main body and a support member body, the resilient portion being connected to the main body.

18. The combined cell module of claim 17, wherein the resilient portion is adapted to expand and contract between the first and second sub-cells so as to reduce the effects of thermal expansion.

19. The combined cell module of claim 18, further comprising a current collecting layer on the second electrode and an interconnection coupling the current collecting layer to the connector across the resilient portion, the interconnection being configured to electrically couple the first and second sub-cells to each other.

20. The combined cell module of claim 1, wherein the connector comprises a first material, wherein the support member comprises a second material, wherein the first and second materials have different coefficients of thermal expansion, and wherein relative lengths of the coupling portion and the support member are configured to reduce the effects of thermal expansion.
